(19) United States
(12) Patent Application Publication
(10) Pub. No.: US 2021/0169734 A1
(43) Pub. Date: Jun. 10, 2021

(54) METHOD OF SUPPRESSING VIBRATION UPON HAND

(71) Applicants: Chen-Hsuan HUANG, Taipei City (TW); Suzhou Pineapple Health Technology Co., Ltd., SuZhou City (CN)

(72) Inventor: Chen-Hsuan HUANG, Taipei City (TW)

(73) Assignees: Chen-Hsuan HUANG, Taipei City (TW); Suzhou Pineapple Health Technology Co., Ltd., SuZhou City (CN)

(21) Appl. No.: 17/116,954

(22) Filed: Dec. 9, 2020

(30) Foreign Application Priority Data
Dec. 10, 2019 (TW) 108145172

(51) Int. Cl. A61H 23/02; F16B 43/00; F16F 3/087; F16F 15/08; F16F 3/093

(52) U.S. Cl. CPC A61H 23/0263; F16B 43/00; F16F 3/0876; F16F 15/08; A61H 2201/0153; F16F 2224/0208; F16F 2230/0005; A61H 2201/0165; F16F 3/0935

(57) ABSTRACT

Disclosed is a method of suppressing vibration of a mechanical device imposing upon at least one human hand holding the mechanical device. The method generally includes steps of preparing and assembling a fixing pin, an upper metal pad, an upper suppressing pad, a lower suppressing pad, and a lower metal pad to form a vibration-suppressing unit, and employing a fixing rack in collocation with an actuating part to fix the vibration-suppressing unit onto a massage body. In particular, the two adjacent upper vibration-suppressing washers are specifically designed to have different elasticity modulus, and the two spaced away and not adjacent upper vibration-suppressing washers have the same elasticity modulus, thereby suppressing and alleviating the vibration level to hand due to counterforce. Thus, the method achieves the effect of suppressing vibration, greatly alleviates counterforce imposing upon hand, and effectively avoiding fatigue, sore, chronical inflammation, or physical hurt.

### CROSS-REFERENCE TO RELATED APPLICATION

This application claims the priority of Taiwanese patent application No. 108145172, filed on Dec. 10, 2019, which is incorporated herewith by reference.

### BACKGROUND OF THE INVENTION

### 1. Field of the Invention

The present invention generally relates to a method of suppressing vibration, and more specifically to a method of suppressing vibration of a mechanical device imposing upon at least one human hand holding the mechanical device utilizing the fixing pin, the upper metal washer, the upper suppressing washer, the lower suppressing washer, and the lower metal washer to form the vibration-suppressing unit, and employing the vibration-suppressing units to collocate with a fixing rack to fix the actuating part onto the massage body, the upper vibration-suppressing washer and the lower vibration-suppressing washer stacked together specifically designed to have the same elasticity modulus, the two adjacent upper vibration-suppressing washers having different elasticity modulus, the two spaced away but not adjacent upper vibration-suppressing washers having the same elasticity modulus, thereby implementing the effect of absorbing vibration strength because of the two adjacent upper vibration-suppressing washers with different elasticity modulus vibrating asynchronously, and suppressing and alleviating the vibration level to hand due to counterforce.

### 2. The Prior Arts

Generally, it is a common disease for people that muscles are easily fatigue, sore, or pain, especially for those who do not instantly exercise or keep a bad posture for a long time. Thus, many devices are developed to alleviate muscular fatigue, sore, or pain. One of the most popular and widely used is a massager.

The conventional massage vibrates by means of a massage head driven by an electric motor using vibration force. The user holds the massager and aligns the massage head to the target portion of human body for massage. Thus, counterforce generated by the massager is directly imposed upon the human hand holding the massager. Since the massager is usually heavy due to the built-in motor and battery pack, the human hand is possibly liable to fatigue after a long time of operation, or other portions of human body like fingers, wrists, and arms potentially suffers from chronic and physical hurt.

Therefore, it is greatly needed to provide a new method of suppressing vibration upon human hand employing the vibration-suppressing units with different vibration suppressing effect and installing the vibration-suppressing units at specific locations to mounting an actuating part onto a case for suppressing original vibration level and protecting hand, thereby overcoming the above problems in the prior arts.

### SUMMARY OF THE INVENTION

The primary objective of the present invention is to provide a method of suppressing vibration upon human hand, comprising the steps S10, S20, S30 S40, S50, S60, S70, S80, and S90 sequentially performed for suppressing vibration of a mechanical device imposing upon at least one human hand holding the mechanical device.

Specifically, the step S10 is performed by preparing a massage body and a holding part. The massage body has a plurality of accommodating parts, and each accommodating part is provided with an accommodating hole. Further, the number of the accommodating parts is an even integer not less than four, and that is, at least four accommodating parts are prepared. In the step S20, a transfer bar, a rotation plate, a rotation axis, and a motor are prepared, and then the step S30 is performed by preparing a fixing rack having a ring part, a center hole, and a plurality of fixing wings. Further, the number of the fixing wings is an even integer not less than four, and that is, at least four fixing wings are prepared. The ring part surrounds the center hole, and the fixing wings are placed on the ring part and outwards extending away from the center hole. Each fixing wing is provided with a fixing hole.

In the step S40, a plurality of vibration-suppressing units are prepared, and each vibration-suppressing unit comprises a fixing pin, an upper metal washer, an upper suppressing washer, a lower suppressing washer, and a lower metal washer. Further, the fixing pin comprises a metal screw with a screw nut, and each of the upper metal washer, the upper suppressing washer, the lower suppressing washer, and the lower metal washer is provided with a center through hole.

Next, the step S50 is performed by assembling the transfer bar, the rotation plate, the rotation axis, and the motor to form an actuating part. Specifically, the transfer bar is eccentrically and rotatably connected to the rotation plate, the rotation plate is further connected to the rotation axis, and the rotation axis is further connected to the motor. In the step S60, the fixing rack is placed and installed by placing the fixing wings in the accommodating parts, and the fixing hole of the fixing wing aligns the accommodating hole of the accommodating part. The step S70 is then performed by employing the vibration-suppressing units and the fixing rack to fix the actuating part onto the massage body. Specifically, the fixing pin sequentially penetrates the center holes of the upper metal washer and the upper vibration-suppressing washer, the fixing hole of the fixing wing, and the center holes of the lower vibration-suppressing washer and the lower metal washer from top to bottom. Thus, the fixing pin is fixedly accommodated in the accommodation hole to fix the actuating part onto the massage body.

The step S80 is performed by electrically connecting the motor and a battery. Finally in the step S90, the massage body and the holding part are connected together to form a case, and the case, the actuating part, the battery, the fixing rack, the vibration-suppressing units are thus assembled to form a massage gun. In addition, the massage gun is intended for inserting into a massage head, and the actuating part contacts and drive massage head to generate the reciprocal massage motion.

Moreover, the upper vibration-suppressing washer and the lower vibration-suppressing washer have the same elasticity modulus, the upper vibration-suppressing washers of the two adjacent vibration-suppressing units have different elasticity modulus, and the upper vibration-suppressing washers of the two vibration-suppressing units not adjacent but spaced away have the same elasticity modulus. It is preferred that the two adjacent upper vibration-suppressing washers have a ratio of elasticity modulus between 1:0.2 and 1:0.9.

In addition, another object of the present invention is to provide a method of suppressing vibration upon human hand, also comprising the steps S10, S20, S30 S40, S50, S60, S70, S80, and S90 sequentially performed for suppressing vibration of a mechanical device imposing upon at least one human hand holding the mechanical device. However, the upper vibration-suppressing washer and the lower vibration-suppressing washer have different elasticity modulus, the upper vibration-suppressing washers of the two adjacent vibration-suppressing units have different elasticity modulus, and the upper vibration-suppressing washers of the two vibration-suppressing units not adjacent but spaced away have the same elasticity modulus. Further, the lower vibration-suppressing washers of the two adjacent vibration-suppressing units have different elasticity modulus, but the lower vibration-suppressing washers of the two vibration-suppressing units not adjacent but spaced away have the same elasticity modulus. It is preferred that the two adjacent upper vibration-suppressing washers have a ratio of elasticity modulus between 1:0.2 and 1:0.9, and the two adjacent lower vibration-suppressing washers have a ratio of elasticity modulus between 1:0.2 and 1:0.9.

Therefore, the present invention assembles the fixing pin, the upper metal pad, the upper suppressing pad, the lower suppressing pad, and the lower metal pad to form a vibration-suppressing unit, and employs the vibration-suppressing units in collocation with a fixing rack to fix the actuating part onto the massage body. In particular, the upper vibration-suppressing washer and the lower vibration-suppressing washer stacked together are specifically designed to have the same elasticity modulus, the two adjacent upper vibration-suppressing washers have different elasticity modulus, and the two spaced away but not adjacent upper vibration-suppressing washers have the same elasticity modulus. As a result, the two adjacent upper vibration-suppressing washers with different elasticity modulus vibrate asynchronously due to different vibration amplitude or frequency to interfere with each other so as to implement the effect of absorbing vibration strength like vibration amplitude and reduce the original rigid vibration, thereby suppressing and alleviating the vibration level to hand due to counterforce.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart showing the method of suppressing vibration upon human hand according to the embodiment of the present invention;

FIG. 2 is a view showing the vibration-suppressing unit employed in the method according to the embodiment of the present invention;

FIG. 3 is a view showing one application example for the method according to the embodiment of the present invention; and

FIG. 4 is a view showing the fixing rack in the application example for the method according to the embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

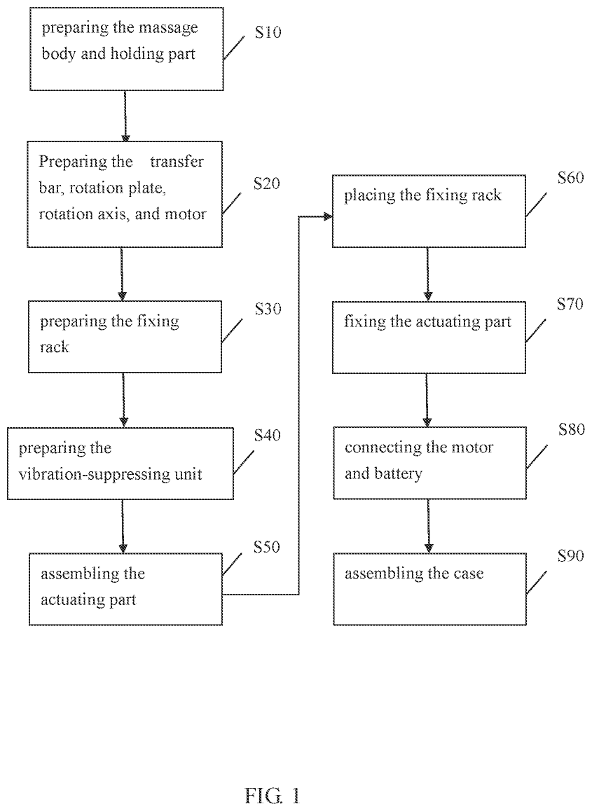

Please refer to FIG. 1 illustrating the flowchart illustrating the method of suppressing vibration upon human hand according to the embodiment of the present invention. As shown in FIG. 1, the method of suppressing vibration upon human hand comprises the steps S10, S20, S30 S40, S50, S60, S70, S80, and S90 sequentially performed for suppressing vibration of a mechanical device like a hand-holding massager imposing upon at least one human hand holding the mechanical device.

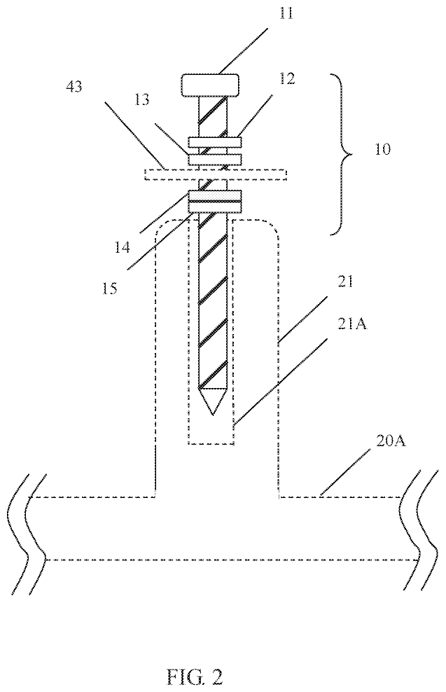

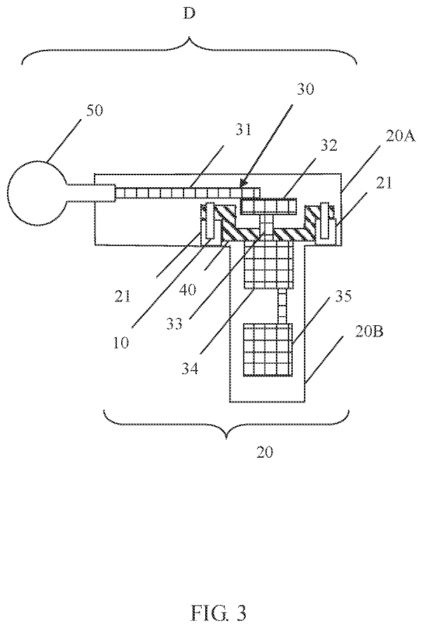

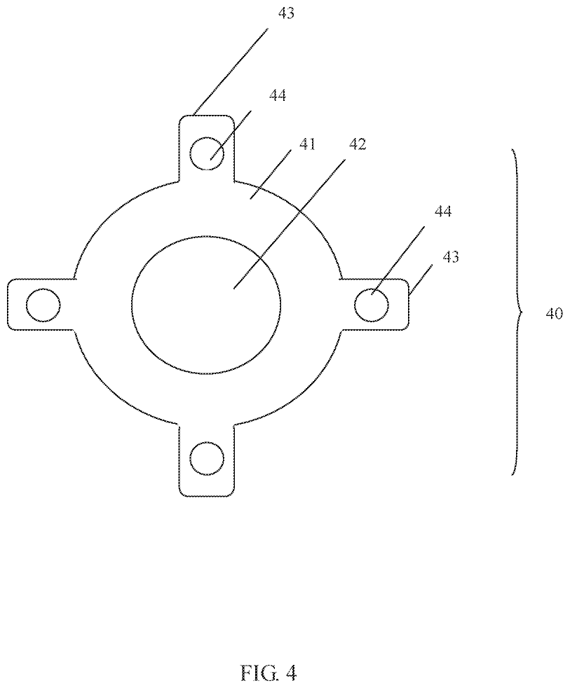

To further clear describe the features and aspects of the present invention, please also refer to FIGS. 2, 3, and 4. Specifically, FIG. 2 is a view showing the vibration-suppressing unit employed in the method according to the embodiment of the present invention, FIG. 3 is a view showing one application example for the method according to the embodiment of the present invention; and FIG. 4 is a view showing the fixing rack in the application example for the method according to the embodiment of the present invention.

As shown in FIGS. 1, 2, 3, and 4, the method of suppressing vibration upon human hand according to the embodiment of the present invention begins at the S10 to prepare a massage body 20A and a holding part 20B. The massage body 20A has a plurality of accommodating parts 21, and each accommodating part 21 is provided with an accommodating hole 21A. Further, the number of the accommodating parts 21 is an even integer not less than four, and that is, at least four accommodating parts 21 are prepared. It is preferred that the accommodating hole 21A is a screw hole. Then the step S20 is performed by preparing and assembling a transfer bar 31, a rotation plate 32, a rotation axis 33, and a motor 34. In the step S30 a fixing rack 40 is prepared, and has a ring part 41, a center hole 42, and a plurality of fixing wings 43. Further, the number of the fixing wings 43 is an even integer not less than four, and that is, at least four fixing wings 43 are prepared. The ring part 41 surrounds the center hole 42, and the fixing wings 43 are placed on the ring part 41 and outwards extending away from the center hole 42. Each fixing wing 43 is provided with a fixing hole 44.

Subsequently, the step S40 is performed, and a plurality of vibration-suppressing units 10 are prepared, each vibration-suppressing unit 10 comprising a fixing pin 11, an upper metal washer 12, an upper suppressing washer 13, a lower suppressing washer 14, and a lower metal washer 15. Preferably, the fixing pin 11 comprises a metal screw with a screw nut, and each of the upper metal washer 12, the upper suppressing washer 13, the lower suppressing washer 14, and the lower metal washer 15 is provided with a center through hole (not shown).

In the step S50, the transfer bar 31, the rotation plate 32, the rotation axis 33, and the motor 34 are assembled to form an actuating part 30. Specifically, the transfer bar 31 is eccentrically and rotatably connected to the rotation plate 32 like an eccentric and rotatable manner, the rotation plate 32 is further connected to the rotation axis 33, and the rotation axis 33 is further connected to the motor 34. For instance, the above eccentric and rotatable manner means that the transfer bar 31 is placed at an eccentric location with respect to a center point of the rotation plate 32, that is, away from the circular center of the rotation plate 32, such that t the transfer bar 31 is driven by the rotation plate 32 to generate the reciprocal motion as desired.

In the step S60, the fixing rack 40 is placed and installed by placing the fixing wings 43 in the accommodating parts 21 of the massage body 20A, and the fixing hole 44 of the fixing wing 43 aligning the accommodating hole 21A of the accommodating part 21. Then, the step S70 is performed by employing the vibration-suppressing units 10 and the fixing rack 40 to fix the actuating part 30 onto the massage body 20A. Specifically, the fixing pin 11 of the vibration-suppressing unit 10 sequentially penetrates the center holes of the upper metal washer 12 and the upper vibration-suppressing washer 13, the fixing hole 44 of the fixing wing 43, and the center holes of the lower vibration-suppressing washer 14 and the lower metal washer 15 from top to bottom.

In the step S80, the motor 34 is electrically connected to a battery 35, and the step S90 is finally performing by connecting the massage body 20A and the holding part 20B to form a case 20. Thus, a massage gun D comprising the vibration-suppressing units 10, the case 20, the actuating part 30, the battery 35, the fixing rack 40 is assembled. For example, the massage body 20A and the holding part 20B are connected by means of lock-fixing or insertion-fixing to form the case 20. In addition, the massage gun D is intended for inserting into a massage head 50, and the actuating part 30 contacts and drive massage head 50 to generate the reciprocal massage motion, thereby implementing a massage function. Furthermore, the motor 34 is powered by the battery 35 to rotate the rotation axis 33, the rotation axis 33 further rotates the rotation plate 32, the transfer bar 31 is driven by the rotation plate 32 to perform the reciprocal motion, and the reciprocal motion drives the massage head 50 to generate the reciprocal massage motion.

More specifically, the upper vibration-suppressing washer 13 and the lower vibration-suppressing washer 14 have the same elasticity modulus, the upper vibration-suppressing washers 13 of the two adjacent vibration-suppressing units 10 have different elasticity modulus, and the upper vibration-suppressing washers 13 of the two vibration-suppressing units 10 not adjacent but spaced away have the same elasticity modulus. It is preferred that the two adjacent upper vibration-suppressing washers 13 have a ratio of elasticity modulus between 1:0.2 and 1:0.9.

Further, the upper vibration-suppressing washers 13 have the same thickness, the lower vibration-suppressing washers 14 also have the same thickness, and the upper metal washer 12 and the lower metal washer 15 have the same or different elasticity modulus, depending on actual applications.

Moreover, another embodiment of the present invention proves the method of suppressing vibration upon human hand, also comprising the steps S10, S20, S30, S40, S50, S60, S70, S80, and S90 to employ the fixing pin 11, the upper metal washer 12, the upper suppressing washer 13, the lower suppressing washer 14, and the lower metal washer 15 to form the vibration-suppressing unit 10 so as to protect human hand. However, the primary difference from the previous embodiment is that the material features of the upper suppressing washer 13 and the lower suppressing washer 14 are different, and particularly, the upper suppressing washer 13 and the lower suppressing washer 14 have different elasticity modulus.

In addition, the upper vibration-suppressing washers 13 of the two vibration-suppressing units 10 not adjacent but spaced away have the same elasticity modulus. Further, the lower vibration-suppressing washers 14 of the two adjacent vibration-suppressing units 10 have different elasticity modulus, and the lower vibration-suppressing washers 14 of the two vibration-suppressing units 10 not adjacent but spaced away have the same elasticity modulus. It is preferred that the two adjacent upper vibration-suppressing washers 13 have a ratio of elasticity modulus between 1:0.2 and 1:0.9, and the two adjacent lower vibration-suppressing washers 14 have a ratio of elasticity modulus between 1:0.2 and 1:0.9. Since other elements have the features as the previous embodiment, the related description is omitted hereinafter. It should be noted that the primary feature of the present invention is to employ the vibration-suppressing unit 10 comprising a fixing pin 11, an upper metal washer 12, an upper suppressing washer 13, a lower suppressing washer 14, and a lower metal washer 15 to achieve the effect of suppressing vibration to protect human hand.

From the above mention, the aspect of the present invention is that the fixing pin, the upper metal washer, the upper suppressing washer, the lower suppressing washer, and the lower metal washer are assembled to form the vibration-suppressing unit, and the vibration-suppressing units are in collocation with a fixing rack to fix the actuating part onto the massage body. Further, the upper vibration-suppressing washer and the lower vibration-suppressing washer stacked together are specifically designed to have the same elasticity modulus, the two adjacent upper vibration-suppressing washers have different elasticity modulus, and the two spaced away but not adjacent upper vibration-suppressing washers have the same elasticity modulus. As a result, the two adjacent upper vibration-suppressing washers with different elasticity modulus vibrate asynchronously due to different vibration amplitude or frequency to interfere with each other so as to implement the effect of absorbing vibration strength like vibration amplitude and reduce the original rigid vibration, thereby suppressing and alleviating the vibration level to hand due to counterforce.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of suppressing vibration upon human hand, comprising:
preparing a massage body and a holding part, the massage body having at least four accommodating parts, each of the accommodating parts provided with an accommodating hole;
preparing a transfer bar, a rotation plate, a rotation axis, and a motor;
preparing a fixing rack having a ring part, a center hole, and at least four fixing wings, the ring part surrounding the center hole, the fixing wings placed on the ring part and outwards extending away from the center hole, the fixing wing provided with a fixing hole;
preparing a plurality of vibration-suppressing units, the vibration-suppressing unit comprising a fixing pin, an upper metal washer, an upper suppressing washer, a lower suppressing washer, and a lower metal washer, the fixing pin comprising a metal screw with a screw nut, each of the upper metal washer, the upper suppressing washer, the lower suppressing washer, and the lower metal washer provided with a center through hole;
assembling the transfer bar, the rotation plate, the rotation axis, and the motor to form an actuating part, the transfer bar eccentrically and rotatably connected to the rotation plate, the rotation plate further connected to the rotation axis, the rotation axis further connected to the motor;
placing the fixing rack by placing the fixing wings in the accommodating parts, the fixing hole of the fixing wing aligning the accommodating hole of the accommodating part;
employing the vibration-suppressing units and the fixing rack to fix the actuating part onto the massage body, the fixing pin sequentially penetrating the center holes of the upper metal washer and the upper vibration-suppressing washer, the fixing hole of the fixing wing, and the center holes of the lower vibration-suppressing washer and the lower metal washer from top to bottom, and fixedly accommodated in the accommodation hole for fixing the actuating part onto the massage body;
electrically connecting the motor and a battery; and
connecting the massage body and the holding part to form a case and further assembling the case, the actuating part, the battery, the fixing rack, the vibration-suppressing units to form a massage gun;
wherein the massage gun is intended for inserting into a massage head, the actuating part contacts and drive massage head to generate a reciprocal massage motion, the upper vibration-suppressing washer and the lower vibration-suppressing washer have the same elasticity modulus, the upper vibration-suppressing washers of the two adjacent vibration-suppressing units have different elasticity modulus, the upper vibration-suppressing washers of the two vibration-suppressing units not adjacent but spaced away have the same elasticity modulus, and the two adjacent upper vibration-suppressing washers have a ratio of elasticity modulus between 1:0.2 and 1:0.9.

2. The method as claimed in claim 1, wherein the motor is powered by the battery to rotate the rotation axis, the rotation axis further rotates the rotation plate, and the transfer bar is driven by the rotation plate to perform a reciprocal motion, and the reciprocal motion drives the massage head to generate the reciprocal massage motion.

3. The method as claimed in claim 1, wherein the upper vibration-suppressing washers have the same thickness, the lower vibration-suppressing washers have the same thickness, and the upper metal washer and the lower metal washer have the same elasticity modulus.

4. The method as claimed in claim 1, wherein the upper vibration-suppressing washers have the same thickness, the lower vibration-suppressing washers have the same thickness, and the upper metal washer and the lower metal washer have different elasticity modulus.

5. The method as claimed in claim 1, wherein the massage body and the holding part are connected by means of lock-fixing or insertion-fixing to form the case.

6. A method of suppressing vibration upon human hand, comprising:
preparing a massage body and a holding part, the massage body having at least four accommodating parts, each of the accommodating parts provided with an accommodating hole;
preparing a transfer bar, a rotation plate, a rotation axis, and a motor;
preparing a fixing rack having a ring part, a center hole, and at least four fixing wings, the ring part surrounding the center hole, the fixing wings placed on the a ring part and outwards extending away from the center hole, the fixing wing provided with a fixing hole;
preparing a plurality of vibration-suppressing units, the vibration-suppressing unit comprising a fixing pin, an upper metal washer, an upper suppressing washer, a lower suppressing washer, and a lower metal washer, the fixing pin comprising a metal screw with a screw nut, each of the upper metal washer, the upper suppressing washer, the lower suppressing washer, and the lower metal washer provided with a center through hole;
assembling the transfer bar, the rotation plate, the rotation axis, and the motor to form an actuating part, the transfer bar eccentrically and rotatably connected to the rotation plate, the rotation plate further connected to the rotation axis, the rotation axis further connected to the motor;
placing the fixing rack by placing the fixing wings in the accommodating parts, the fixing hole of the fixing wing aligning the accommodating hole of the accommodating part;
employing the vibration-suppressing units and the fixing rack to fix the actuating part onto the massage body, the fixing pin sequentially penetrating the center holes of the upper metal washer and the upper vibration-suppressing washer, the fixing hole of the fixing wing, and the center holes of the lower vibration-suppressing washer and the lower metal washer from top to bottom, and fixedly accommodated in the accommodation hole for fixing the actuating part onto the massage body;
electrically connecting the motor and a battery; and
connecting the massage body and the holding part to form a case and further assembling the case, the actuating part, the battery, the fixing rack, the vibration-suppressing units to form a massage gun;
wherein the massage gun is intended for inserting into a massage head, the actuating part contacts and drive massage head to generate a reciprocal massage motion, the upper vibration-suppressing washer and the lower vibration-suppressing washer have different elasticity modulus, the upper vibration-suppressing washers of the two adjacent vibration-suppressing units have different elasticity modulus, the upper vibration-suppressing washers of the two vibration-suppressing units not adjacent but spaced away have the same elasticity modulus, the two adjacent upper vibration-suppressing washers have a ratio of elasticity modulus between 1:0.2 and 1:0.9, the lower vibration-suppressing washers of the two adjacent vibration-suppressing units have different elasticity modulus, the lower vibration-suppressing washers of the two vibration-suppressing units not adjacent and spaced away have the same elasticity modulus, and the two adjacent lower vibration-suppressing washers have a ratio of elasticity modulus between 1:0.2 and 1:0.9.

7. The method as claimed in claim 6, wherein the motor is powered by the battery to rotate the rotation axis, the rotation axis further rotates the rotation plate, and the transfer bar is driven by the rotation plate to perform a reciprocal motion, and the reciprocal motion drives the massage head to generate the reciprocal massage motion.

8. The method as claimed in claim 6, wherein the upper vibration-suppressing washer have the same thickness, the lower vibration-suppressing washer have the same thickness, and the upper metal washer and the lower metal washer have the same elasticity modulus.

9. The method as claimed in claim 6, wherein the upper vibration-suppressing washer have the same thickness, the lower vibration-suppressing washer have the same thickness, and the upper metal washer and the lower metal washer have different elasticity modulus.

10. The method as claimed in claim 6, wherein the massage body and the holding part are connected by means of lock-fixing or insertion-fixing to form the case.
